(19) United States
(12) Patent Application Publication
(10) Pub. No.: US 2016/0091000 A1
(43) Pub. Date: Mar. 31, 2016

(54) DEVICE FOR THE STORAGE AND GENERATION OF POWER

(71) Applicant: SWISS GREEN SYSTEMS SAGI, Lugano (CH)

(72) Inventor: Gianfranco GALLINO, Bellinzona (CH)

(21) Appl. No.: 14/891,460

(22) PCT Filed: May 2, 2014
(86) PCT No.: PCT/IB2014/000650

§ 371 Date: Nov. 16, 2015

(30) Foreign Application Priority Data
May 17, 2013 (CH) 00978/13

(51) Int. Cl. F15B 15/14; F15B 21/14; F15B 1/033

(52) U.S. Cl. CPC F15B 15/1447; F15B 1/033; F15B 21/14; F15B 2015/1495; F15B 2211/7058

(57) ABSTRACT

Device (100) for the storage and production of electric power includes:
at least one energy source, preferably a source (400) of renewable energy;
at least one pump (200), supplied by the energy source (400), adapted to compress the air inside a storage tank (6) of compressed air so that to feed it to at least one primary pneumatic actuator (1) connected to at least one secondary pneumatic actuator (1a), preferably connected to a plurality of secondary pneumatic actuators (1a, 1b, 1c), via pressurized pipings (3 and 4) and electrovalves (150 and 298);
at least one transmission assembly (21) adapted to transform the reciprocating rotary motion of the pneumatic actuators (1, 1a, 1b, 1c) in a constant rotary motion;
at least one electric generator connected to the transmission assembly (21) adapted to produce electric power when necessary.

### STATE OF THE ART

At the present time all industrial devices adapted for the production of non-renewable electric power, independently from their size, are characterized by a poor thermodynamic efficiency. Classic internal combustion engines, independently from being two stroke or four stroke engines and independently from being fed with petrol, kerosene, methane, LPG or gas oil, have unfortunately a mechanical efficiency lower than 30%. The unsolved problem of all internal combustion devices currently available on the market is the extreme energy waste related to the intrinsic heat production typical of the structure and design itself of these engines. The speed, at which the combustion happens, together with their mechanical complexity, dissipates inevitably a high energy amount as heat. Obviously, in order to disperse in the environment the uselessly produced heat, every internal combustion engine is inevitably combined with bulky exchangers or radiators, adapted to dissipate the produced thermal power. In addition, toxic emissions are inevitably associated with the existing internal combustion engines, coming from the combustion of the used hydrocarbons themselves, which are harmful for both the environment and the human health. On the whole, also hydrogen engines demonstrated to have a very little energy efficiency, even lower than 40%. Similarly, all thermal power plants actually working have similar criticality. Poor thermodynamic efficiencies, emissions harmful for the environment and high heat production. Due to the size of this typology of industrial plants, the loss of produced heat is so high to recommend to locate these thermal power plants next to rivers, lakes or still better next to the sea. Speaking about energy:the situation is critical and anyway correlated to devices and plants which are conceptually outworn and provided with poor efficiency and little performance. The overall situation is even worse if criticalities related to the production of atomic energy are analyzed. In this case, in addition to the poor plant efficiency, high production costs and little operative duration of the same, unsolved problems relating the production of radioactive wastes, their management and safe disposal have to be added. As if all this was not enough, all dimensionally significant plants for the production of non-renewable energy, have the disadvantage of being little adaptable, i.e. they are plants that, because of their size and design, are not able at all to modulate their power production over time, or they can do it only partially. The power requirement of each country is very variable over 24 hours, as anyone knows. As a matter of fact, the consumption varies appreciably as a function of user requirements during twenty four hours, so that in Italy the consumption changes from 22 GW in the middle of the night to over 50 GW around noon. In conclusion, the energy consumption varies of 60% during the day, thereby assuming a high modulation ability of production plants. As previously mentioned, most of all the greatest thermal power plants and nuclear plants have great difficulties in reducing or increasing suddenly their power production. This situation causes an energy imbalance in domestic electric networks, thereby methods and devices adapted to allow the power storage when the requirements are lower become essential, i.e. during the night, making it again available when the requirements are greater such as, for example, during the day. In every country this intermittent requirement of electric power further decreases the efficiency of power systems, revealing the need of having a new and efficient method adapted to allow the power storage when there are lower requirements, but allowing its sudden release at user needs. Desirably, all this is carried out with a high efficiency.

### FIELD OF THE INVENTION

The present invention has the intention to solve all the afore said drawbacks, describing an innovative device for the storage and production of electric power that has to be safe, inexpensive and able to store high power amounts but, at the same time, being able to return it again on the electric network in a highly efficient way as requirements of electric power increase.

### DESCRIPTION OF THE INVENTION

The present Application describes and claims an innovative electropneumatic device substantially composed of two independent sub-units, connected one to another through a common pressurized piping.

The first sub-unit is composed of a pump, preferably it is composed of a plurality of pumps, still more preferably it is composed of a series of three pumps, which are adapted to allow the potential energy to be stored as compressed air inside one or more apposite storage tanks of said compressed air, so that to be able to feed it to the second sub-unit through at least one pressurized piping.

Said second sub-unit is composed of at least one couple of motors or pneumatic actuators, preferably a plurality of pneumatic actuators, activated in an orderly sequence according to a precise scheduled scheme by the compressed air previously stored up in the storage tank and fed to the first of said pneumatic actuators through a pressurized piping. The reciprocating oscillatory motion, made by said activated pneumatic actuators, is transmitted to a transmission assembly adapted to transform the oscillatory motion typical of said pneumatic actuators in a continuous rotary movement, said transmission assembly being in turn connected to a conventional electric generator.

The first sub-unit of the present invention is provided with an appropriate storage tank, said storage tank of compressed air can be any tank sufficiently strong and safe for the containment of said air, alternatively, said tank can be made so as to have, in its inside, a plurality of sectors, preferably four sectors, adapted to delimit zones of compressed air characterized by different pressures. For example, a zone with maximum pressure at about 80, 100 bars, a zone of medium pressure at about 40, 60 bars, a zone of low pressure at about 25, 30 bars, and lastly a zone of maximum pressure at about 15, 20 bars. Said zones are connected one to another by at least one pressure reducer, independently from how many they are. Said devices for reducing the pressure can be electrically controlled conventional taps adapted to be opened and closed to create or prevent the connection among different independent zones of said tank, so as to distribute the compressed air among said zones according to what imposed by the control unit. The control unit analyzes data coming from the manometers placed in every independent zones, by processing them in order to optimize the distribution of compressed air inside every single zone and the whole tank, so as to maintain the desired pressure as a function of the instant consumption and the instant pumping capacity (related to the power available at that time). This differentiation in the inner structure of the storage tank of the compressed air allows to store up great air amounts at high pressures in relatively little spaces. This is an essential feature in case renewable energy is available. These energy sources, as a matter of fact, being bound to the unforeseeability of weather conditions, independently from being wind or solar energy, must be necessarily stored up in great amounts as compressed air, when the nature makes them available. As a consequence the need of a multi-stage tank arises, which is relatively little and then able to be installed in every garden or roof of every building, and adapted to store up great amounts of high pressure compressed air, up to about 80, 100 bars. The described tank is equipped with a plurality of electrically controlled taps, as many as the compartments it is provided with, so as to feed the primary pneumatic actuators at a pressure of compressed air of about 10 bars. For plants having greater dimensions and for storing great amounts of compressed air, galleries and tunnels present on the territory but no longer in use can be employed. Thanks to the generous capacity of these cavities, great amounts of compressed air can be stored effectively just in hours in which the power requirement is minimum. The tightness, the management simplicity and the total absence of toxicity of this power storage technique allows economic saving, an optimum safe level and duration almost unlimited of these storage deposits. As it has no practical contraindication, the storage of compressed air inside said galleries and tunnels and its subsequent use, could be carried out infinitely, without damaging things or humans. If these galleries will have to be reconverted to other purposes, they would be immediately available and substantially ready for the new uses. The storage of compressed air, in order to increase its efficiency, is carried out preferably through a plurality of compressors. In fact, every compressor is provided with a specific capacity and compression efficiency and then it is used exclusively as a function of the pressure present in the storage tank in that moment. Substantially, when the pressure inside the storage tank is low, all compressors are activated, when it is medium the second compressor is activated, and when the maximum pressure has to be reached, the third compressor is activated. Alternatively, the plurality of compressors can operate individually or in combination, as a function of the power available in such a moment. Therefore, if for example the plant is fed by solar energy and a bright spell happens in a cloudy day, all pumps can be activated simultaneously also if this way is not the most efficient for the power storage. On the contrary, if the plant would have not much power available, only the most little pump would be activated that could operate also at reduced speed, because of being fed by direct current. Obviously, thanks to a conventional inverter, the alternating current can also be used. Alternatively the three compressors can operate in sequence, each one compressing the air up to a certain pressure. When the air pressure reaches about 10 atms, the air can be entered directly into the storage tank from the first air compressor through a piping provided with a check valve, or else it can be sent to the second compressor through a piping provided with a check valve. Said second compressor further comprises the air coming from the first compressor, up to reach a pressure of about 20 atmospheres. In its turn, the air compressed by the second compressor can be directly entered into the storage tank through a piping provided with a check valve, or else it can be sent to a third compressor, adapted to further compress the air coming from the second compressor, through an appropriate pipeline. The third compressor, when a pressure of about 30 atmospheres is reached, enters said air into the storage tank or the gallery conveniently arranged for the so-compressed air containment. Obviously, the storage tank of compressed air, independently from the pressure in its inside, is provided with at least one check valve for compressed air that is placed on every single piping or pipeline feeding it. Substantially, thanks to the modularity of the control unit, all possible combinations can be achieved in order to exploit and optimize at best the single independent storage zones of compressed air.

By providing for a national use, it is necessary to provide for the use of a lot of galleries in order to have a sufficient number of tanks for the storage of compressed air. Every unexpected and accidental loss of compressed air, by being not toxic, would not cause any collateral damage if not the simple drop of system efficiency.

Therefore, the afore said storage system of compressed air allows, at first, to transform the electric power into mechanic power and then the mechanic power into pneumatic power in the guise of compressed air. Obviously, the afore said storage system of compressed air can be effective also for domestic use, i.e. by using a tank of compressed air having little size for family use, adapted to be automatically filled at the middle of the night, when the cost of electric power is greatly lower than the daily one. The system of compressed air, i.e. the various pumps, can be fed by the electric current of the network, by any generator, or else by any renewable energy source such as, for example and not limitatively, photovoltaic panels, aeroturbines or hydroelectric turbines. For illustration purposes, 1 cubic meter of compressed air at 30 bars, by adopting the scheme described in the present Application, can approximately produce about 2 KWh of electric power.

The second unit of said electropneumatic device is focused on the high operation efficiency of pneumatic actuators characterizing it. In the present invention, the motors or pneumatic actuators are used according to a precise scheme that is described in the following of the present Application. The operating scheme of the pneumatic actuators in the present Application provides for the feed of compressed air coming from the pressure reducer connected to the tank, at a final pressure of about 10 bars, to the pneumatic primary actuator. When then work has been carried out, the latter sends the emitted compressed air to at least one secondary pneumatic actuator, preferably to a plurality of secondary pneumatic actuators. Every pneumatic actuator is provided with a maximum travel of 270°, but it can be used in the most convenient range by also exploiting an oscillation with many degrees less. Substantially, every pneumatic actuator has to be considered as a compressed-air motor having an oscillating movement. At least one couple, preferably a plurality, of said pneumatic actuators are connected to a permanent-magnet three-phase electric generator. Said connection happens by means of a specific mechanical converting system, named as mechanical coupler or transmission assembly, adapted to transform the oscillating movement typical of said pneumatic actuators into the continuous rotary movement suitable to create electric power. The operating pressure and the air flow adapted to active said pneumatic actuators, conveniently arranged in the first and second stages as described in the following, are managed by electrovalves having adjustable frequency.

The primary pneumatic actuator of the second sub-unit, i.e. the pneumatic actuator arranged more upstream, is directly fed by the compressed air coming from the pressurized piping at about 10 bars, extending from the storage tank of compressed air and ending directly into the feed duct of the first pneumatic actuator. The pneumatic actuators are arranged so as to integrally recover the air discharged from two side vents, during the normal operation of the first pneumatic actuator, by means of an appropriate couple of pipes for the air recovery. The air discharged from the two side vents of the first pneumatic actuator is, as a matter of fact, still provided with a pressure extremely higher than the atmospheric pressure and then it is still be used for carrying out a mechanical work. In order to prevent the useless dispersion of such an energy into the environment and to exploit said residual pressure differential at best, the air discharged from the two side vents of the primary pneumatic actuator is directly entered into the first couple of pipe for recovering the emitted air and is sent directly to the duct feeding the secondary pneumatic actuators. The high pressure the air still has, now actives said secondary pneumatic actuators arranged exactly on the same axis but downstream of the primary pneumatic actuator. The air coming out from the side vents of the last pneumatic actuator, being now unable of making any mechanical work, is simply released into the outer environment because of not having, by now, any pressure differential significant with respect to the atmospheric pressure. The sequence of pneumatic actuators, together with their direct connection and by being arranged on the same axis, allows to exploit the pressure drop at best, thereby achieving a very high efficiency in exploiting the compressed air previously stored in the storage tank. Obviously, if the starting pressures are higher than 10 bars, it is possible to sequentiate additional pneumatic actuators, till obtaining anyway a pressure, in the side vents, a little higher than the atmospheric pressure, i.e. higher than the atmospheric pressure of about 0.2-0.5 bars. Therefore, the distribution of the primary actuator and the secondary pneumatic actuator/s, forces the used compressed air to carry out all the mechanical work that can be obtained by exploiting its potential energy. On the contrary, if a very low pressure is available, it would be possible to use only one couple of pneumatic actuators as, in this case, the pressure exiting from the side vents of the secondary pneumatic actuator would already be just a little higher than the atmospheric pressure and then no more usable to carry out a work efficiently. The afore described different compressed-air motors, defined as pneumatic actuators, must all necessarily have the same size. This detail becomes necessary in that, differently, instabilities could arise. If a plant having great size has to be made, it is preferred having several main motors, that is a greater number of primary pneumatic actuators, instead of having only one great motor. This because, in this case, the pressure would be better distributed, thereby having the higher incoming pressure immediately. Obviously, every single outlet present in the primary pneumatic actuators according to the present invention, must be provided with at least one check valve.

### DESCRIPTION OF THE DRAWINGS

Let's now proceed to the detailed description of the drawings the present invention is provided with, in which devices and apparatuses connected to the present invention are described for purposes of illustrations and not limitative, in which:

FIG. 1 is an overall view of the whole device 100 according to the present invention;

FIG. 2 is a partially exploded schematic view of the whole electropneumatic system 300 according to the present invention;

FIG. 3 is a plant view of the electropneumatic actuator 1 according to the present invention;

FIG. 4 is a side sectional view of the transmission assembly 21 alone, according to the present invention;

FIG. 5 è a general scheme only of the system for generating the compressed air according to the present invention;

FIG. 6 is a perspective view of the electropneumatic system 300 according to the present invention;

FIG. 7 is the operating scheme of the primary pneumatic actuator l and of the three secondary pneumatic actuators 1a, 1b, 1c arranged one in parallel to another.

### DETAILED DESCRIPTION OF THE INVENTION

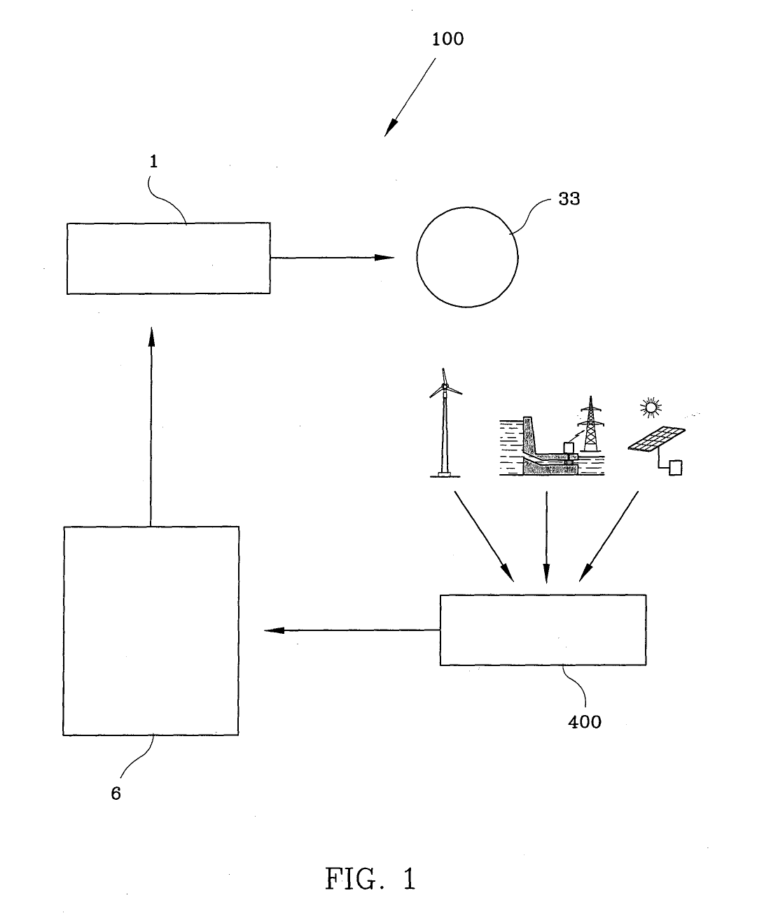

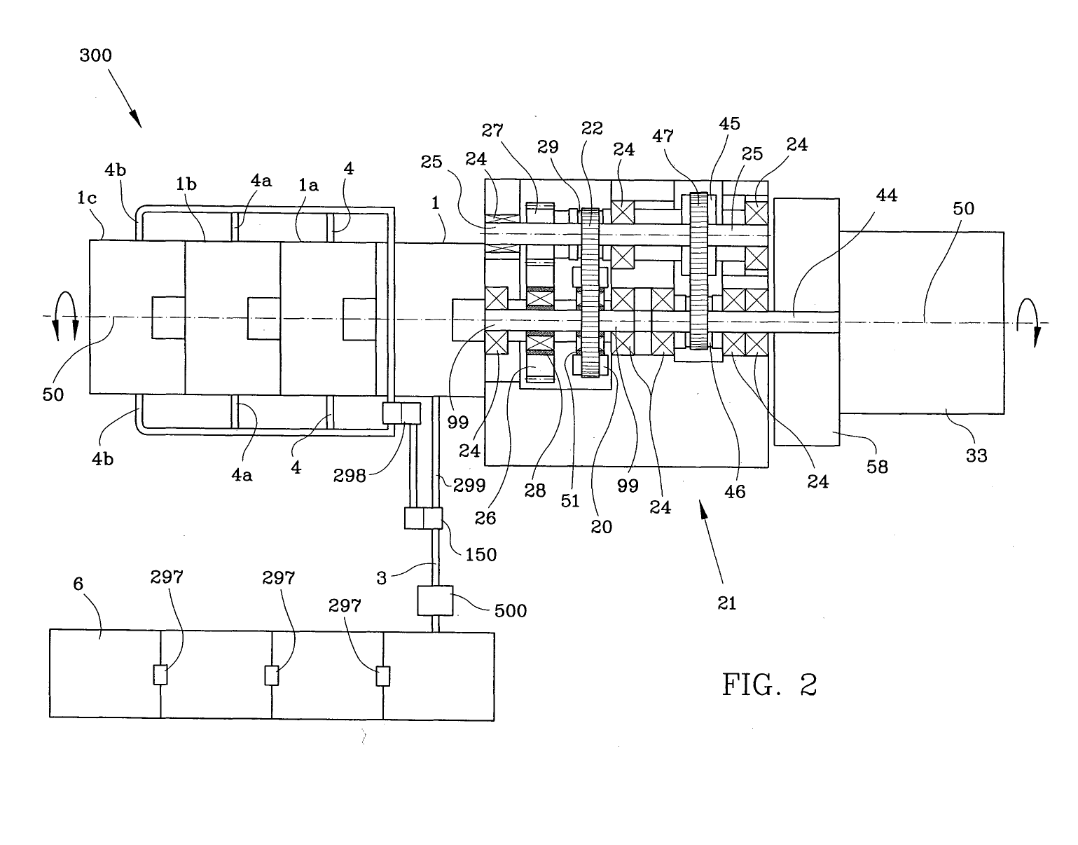

As evidently shown in FIG. 1, the present device is characterized by a plurality of components that, by operating synergistically, allows to achieve the object of the present invention. The operative scheme of the whole device 100 is composed of a system for the storage of compressed air and the production of electric power, by using compressed air as methodology for storing up the energy according to the present invention. In the scheme it can be noticed that the device is fed by any source of electric power 400, preferably any renewable energy source, adapted to feed at least one compressor 200 prearranged to compress the atmospheric air till a maximum pressure of about 100 bars, so that to be able to store it, as compressed air, into the tank 6. The air compression in the storage tank 6 of compressed air happens thanks to the system of high efficiency pumps 200. Therefore, said compressed air is sent to a plurality of pneumatic actuators 1, 1a, 1b, 1c through pressurized pipings 3. Said pneumatic actuators are adapted to transform said compressed air into mechanic power thanks to the transmission assembly 21 that transforms the oscillatory motion, made by said pneumatic actuators, into the continuous rotary motion and the latter into electric power ready to be used, thanks to the generator 33, or entered into the network. In FIG. 2, a schematic representation is shown in which there are four pneumatic devices or actuators 1, 1a, 1b, 1c, activated by the compressed air and all installed along the axis 50. Said axis 50 is, in its turn, connected to the transmission assembly 21, in its turn combined with an ordinary electric generator 33 adapted to produce the electric power at the desired voltage. FIG. 2 shows in detail an overall exploded view of the transmission assembly 21, adapted to transform the reciprocating rotary motion of a first element (specifically the plurality of pneumatic actuators 1, 1a, 1b, 1c), into the continuous rotary motion of a second element connected thereto (specifically the electric generator 33) through the transmission assembly 21 itself. The actuators 1, 1a, 1b, 1c are reverse-flow rotary pneumatic actuators. The presence of the transmission assembly 21 is essential for transforming the movement reversal, typical of these actuators, into the constant rotary motion indispensable for the production of electric power. The primary pneumatic actuator l is fed by the pressurized piping 3, coming from the tank 6. At least one pressure reducer 500 and one electrovalve 150, the latter being aided by two coils for its correct operation, are present on said pressurized piping 3. The opening and closing scheme of said electrovalve 150 is shown in detail in FIG. 7, from this one can infer that the compressed air coming from said electrovalve 150 feeds alternately the two chambers A and B of the primary pneumatic actuator l, then the air discharged from the pressurized ducts 4 feeds the sequence of secondary pneumatic actuators 1a, 1b, 1c mounted in parallel one to another. The pneumatic actuator 1c discharges directly into the environment the air fed by the pressurized pipe 4. Therefore, the compressed air coming from the storage tank 6 is fed to at least one pressure reducer 500 so that to feed it to the primary pneumatic cylinder/s 1 at a pressure of about 10 bars. The air emitted from said primary actuator 1 is sent, through a pressurized pipeline, to a second electrovalve 298 feeding, through the pressurized pipings 4, 4a and 4b, the secondary actuators placed in parallel one to another. It has to be outlined that the air emitted into the pipelines 4 by the primary pneumatic actuator l is not released into the atmosphere. Said air, having a pressure considerably higher than the atmospheric pressure, around 4 bars, is completely sent to the pressurized pipelines 4 and used to activate a plurality of secondary actuators 1a, 1b, 1c thanks to the second electrovalve 298. After said secondary actuators have been activated, the air is provided with a pressure a little higher than the atmospheric pressure and, as it cannot be used for any work, it is now released into the environment. The release of said exhausted air into the environment happens by the electrovalve 298 that is provided with appropriate vents. The number of secondary pneumatic actuators is such to reduce the pressure difference from the atmosphere to the air emitted by said secondary pneumatic actuators, in a range of about 0.2 bars.

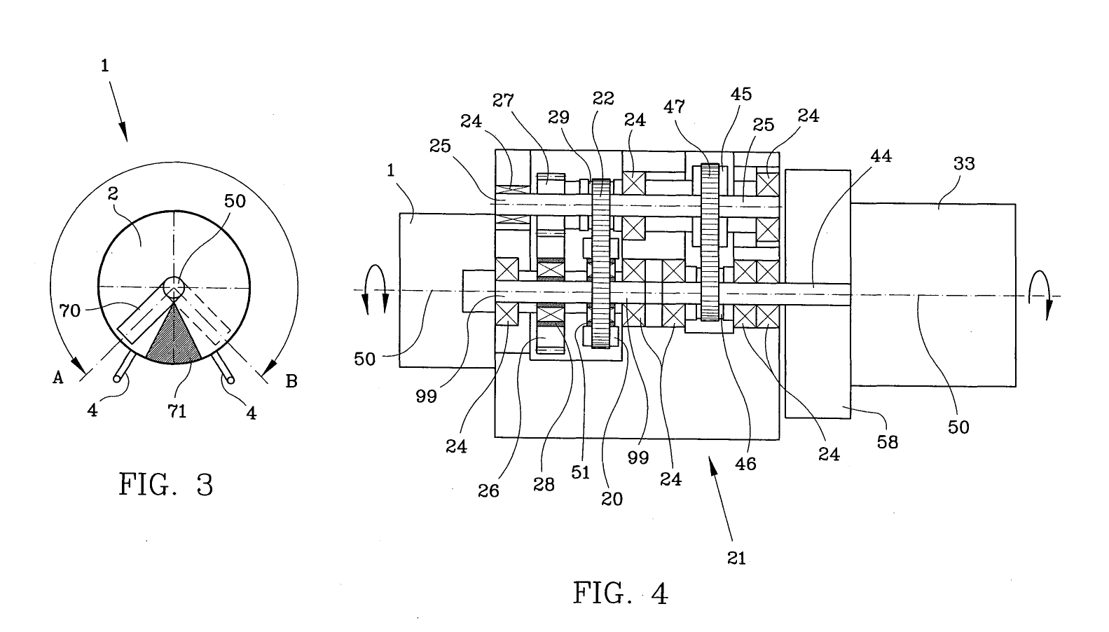

The pneumatic actuator 1 is a reverse-flow rotary pneumatic actuators, specifically in FIG. 3 the pneumatic actuator is shown, in which the piston 70 is provided with an oscillatory motion of 270° (illustrated in FIG. 3 by the arrows A and B) and characterized by the presence of the separating zone 71 and the couple of pressurized pipings 4. The oscillation of 270° is made by the piston 70 in its regular working cycle around the axis 50. Said oscillation has a maximum amplitude of 270°, but the oscillation angle depends from the work frequency. Higher said frequency is, lower said oscillation angle will be. Independently from the oscillation angle, the transmission assembly 21 is anyway able to transform said reciprocating oscillatory movement into the continuous rotary movement essential for producing the electric power. The oscillatory frequency is directly correlated to the request of electric power in that moment. The two chambers A and B are separated one from another by the piston 70 and the separating zone 71, said chambers fill and empty with/from compressed air alternately, thanks to the action of the pressurized ducts 4 in their turn connected and controlled by the electrovalve 150, in case of the primary pneumatic actuator, or else 298, in case of secondary pneumatic actuators.

The transmission assembly 21 is adapted to transform the reciprocating rotary motion of a first element, i.e. the actuators 1, 1a, 1b, 1c, into the continuous rotary motion of a second element connected thereto, i.e., of the flywheel 58 and the electric generator 33. The pneumatic actuators 1, 1a, 1b, 1c are reverse-flow rotary pneumatic actuators, in order to transform the movement reversal typical of these actuators into a constant rotary motion, essential for adjusting the production of electric power, the transmission assembly 21 becomes necessary. It has to be noticed that all the pneumatic actuators 1, 1a, 1b, 1c are neatly arranged along an end of the axis 50. On the contrary, the central portion of the axis 50 is inside the transmission assembly 21 itself, on said portion of the axis 50 a gear wheel 26 is mounted. The first freewheel 28, provided with only one and specified mesh way, is interposed between said gear wheel 26 and the shaft 99. A second gear wheel 27, adapted to engage with said first gear wheel 26, and a gear pulley 20, in its turn connected to the second gear pulley 29 through a first drive belt 22, are keyed on a second shaft 25 parallel to said first shaft 99. Said second gear pulley 29 is keyed on the second shaft 25 on which also the second gear wheel 27 is installed. The first gear pulley 20 is keyed on the first shaft 99 on which also the first gear wheel 26 is mounted with the respective first freewheel 28. A second freewheel 51, characterized by having a mesh way opposite with respect to that of the first freewheel 28, is installed between said first gear pulley 20 and said first shaft 99. The electric generator 33 must now rotate in a constant way because of the effect of the transmission system 21, being keyed on a third shaft 44 with which it rotates integrally always in the same way. The first shaft 99 and the third shaft 44 are on the same axis 50. This effect is possible thanks to the third shaft 44, having the longitudinal axis perfectly aligned to that of the first shaft 99, being placed side by side in parallel to the second shaft 25. The shaft 99 and the shaft 44, although being perfectly aligned, are not interconnected directly but they are separated and aligned one to another. The second shaft 25 and the third shaft 44 are connected one to another by means of a second toothed belt 47 placed between a third gear pulley 45 and a fourth gear pulley 46 keyed on the second shaft 25 and the third shaft 44, respectively. The third gear pulley 45 and the fourth gear pulley 46, thanks to the afore said kinematic systems, independently from the activation way of the pneumatic actuator 1, continue rotating in the same direction, thereby transmitting such a constant rotary movement to the electric generator 33. Obviously, the shafts 99, 25 and 44 will have to be installed on apposite bearings interposed among said shafts and the supports 24. The flywheel 58, placed on the shaft 44, is between the transmission assembly 21 and the electric generator 33.

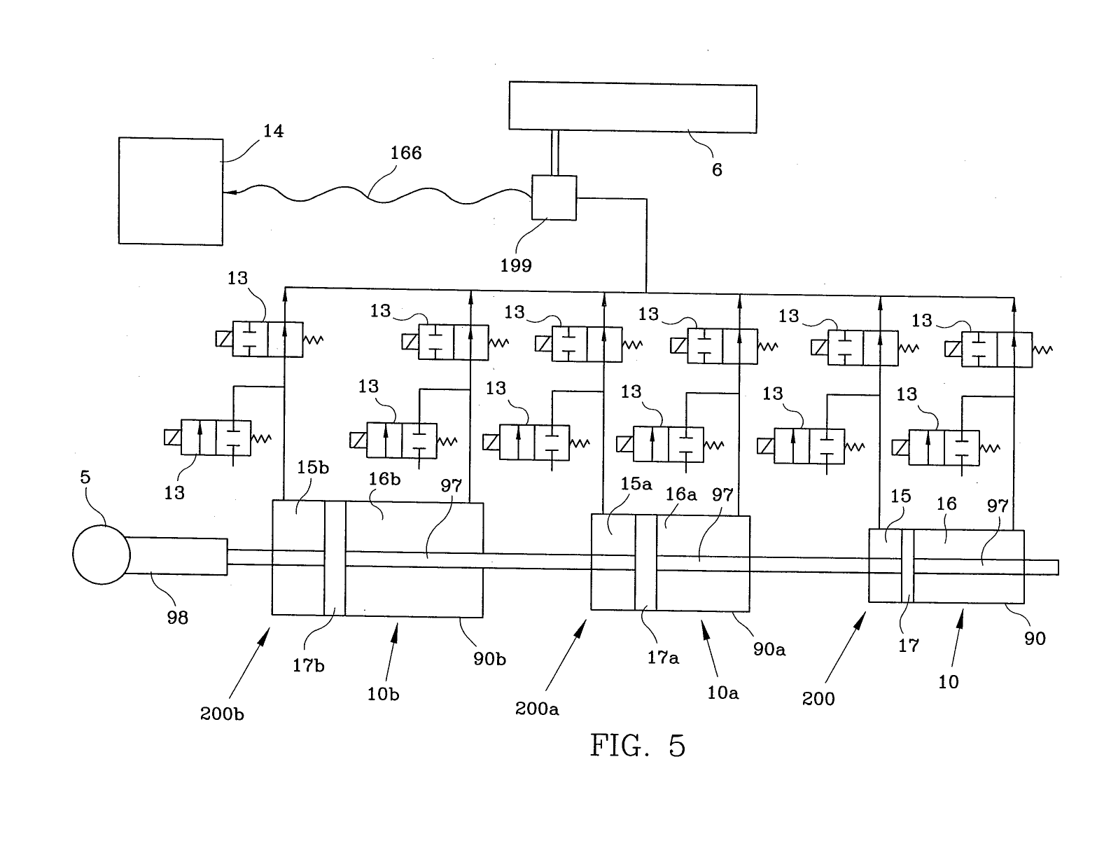

In FIG. 5, it is clearly represented a schematic view of the system for generating compressed air according to the present invention, in which the pumps, in whose inside there are the three pistons 17, 17a, 17b respectively belonging to the three cylinders 90, 9a, 9b, are highlighted with the numerals 200, 200a, 200b. However, said pistons 17, 17a, 17b have different compression capacities and, therefore, when a lower pressure is sufficient to storage the compressed air, i.e. when for example the tank of compressed air 6 is half-empty, it will be sufficient to activate the piston 17b with a lower compressive capacity in order to fill it. But if the tank 6 of compressed air would be empty and great amounts of electric power could be available at reduced costs, or else if a significant solar irradiation could be available, it will be possible to make all pistons work simultaneously till the desired pressure of compressed air is reached. The activation mechanism is automatically managed by the control unit 14 that can activate the valves 13, which are adapted to provide the minimum pressure of compressed air necessary to allow said tank 6 to be filled by using the possible minimum power, by analyzing the pressure data received from the manometers placed in distinct zones of the tank 6 of compressed air. Every single pumping chamber 15 and 16, 15a and 16a, 15b and 16b, respectively of the cylinders 90, 90a, 90b, is connected to a couple of valves 13 controlled by the control unit 14. This distinctive feature allows to draw out the compressed air from every pumping chamber 15 and 16 of every cylinder 90, when the pistons 17, 17a, 17b are in both the back and forth steps, creating a double pumping effect. The valves 13 open when electrically activated by the control given by the control unit 14, and they close automatically with a conventional spring-driven return mechanism, thereby avoiding the compressed air from flowing back through the valve 13 itself. As a matter of fact, the couple of valves 13 combined with every piston 17, 17a, 17b is managed by the electronic control unit 14 that analyzes the single pressure data, allowing the valves 13 connected to every single pumping chambers 15, 15a, 15b to be opened and closed alternately, thereby allowing to perfectly control both the flow of compressed air exiting from the pumping chambers 15 and 16 and the flow of incoming atmospheric air. Therefore, by way of explanation, in the forth step of the piston 17, the pumping portion 15 provides the compressed air to the tank 6, whereas during the back step of the piston 17, the pumping chamber 16 will provide said compressed air to the tank 6. All synergistically managed by the opening and closing of the valves 13, as mentioned above, which also avoid the reflux of compressed air. In short, the air compressors 10, 10a, 10b are activated by an electric motor 5 provided with a reducer, said electric motor 5 being preferably fed by renewable electric power. The electric motor 5 is provided with a screw mechanism 98 provided with ball bearings. The electric motor 5 is connected to at least one air compressor 10, preferably to three air compressors 10, 10a, 10b, all mounted along the same axis, represented in FIG. 5 by the drive shaft 97 itself. The pistons 17, 17a, 17b can therefore move alternately, inside the cylinders 90, 90a, 90b, when they are operated by the drive shaft 97. Therefore, it is the accurate opening and closing of the couple of valves 13, which are controlled by the control unit 14 and connected to every single pumping chamber 15 and 16, 15a and 16a, 15b and 16b, to determine which pump/s 10 must be operated, in every given moment, in order to optimize the energy consumption in the production of compressed air. The digital analog manometer 199 is adapted to provide the control unit 14 with data relative to the pressure inside the tank 6 so that to activate the valves 13 connected to the preferred pump 200 in order to optimize the distribution of compressed air inside the single zones of the tank 6. As previously described every independent zone is provided, in its inside, with a manometer and at least one electrically controlled tap managed by the control unit, in its turn directly connected to said manometers.

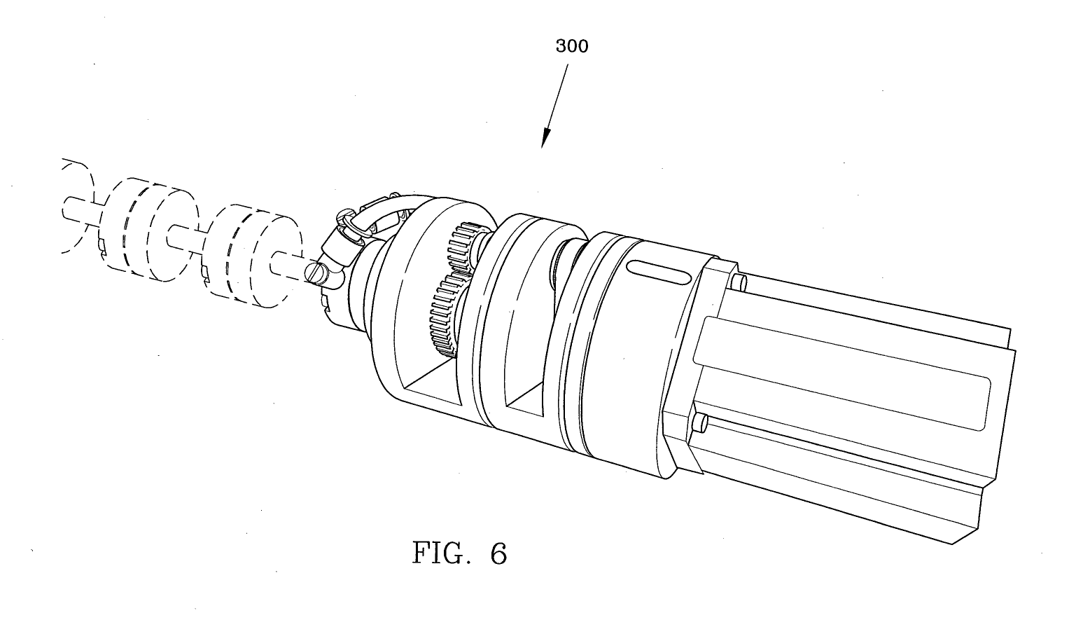

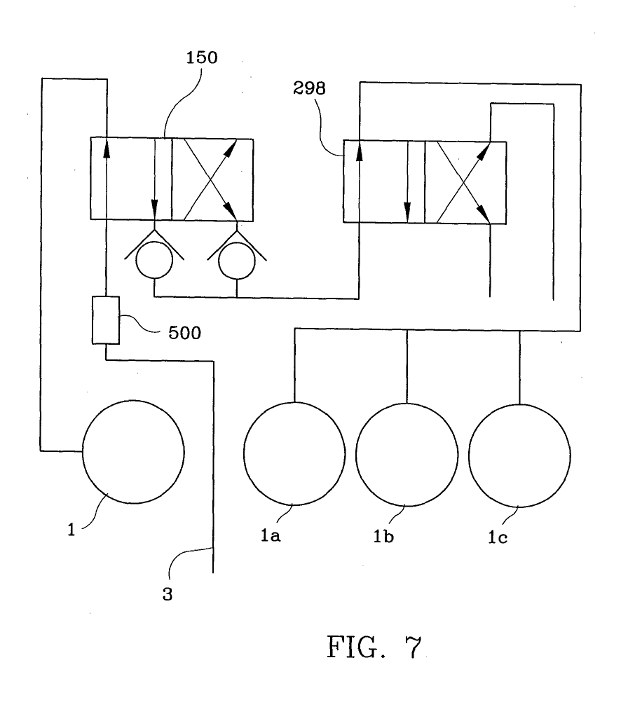

In FIG. 6 a schematic view of the whole electropneumatic system 300 is shown for better illustrating the present Application in which the pneumatic actuators can be noticed in a dotted line, which are perfectly arranged in-line with the transmission assembly in its turn directly connected with the generator. The efficiency of the device 300 object of the present Application, is about 80%. This excellent result has been detected by means of objective and incontestable measuring. The present device allows to produce electric power starting from a reserve of compressed air, previously stored in an apposite tank, thanks to the pumps preferably operated by renewable energy. In this latter case, the whole cycle has zero impact, i.e. it causes no damages to the environment, it does not release carbon dioxide into the environment and does not create any toxic waste.

1. Device (100) for the production of electric power comprising:
at least one energy source, (400) preferably of renewable energy, adapted to activate at least one electric motor (5) connected through a screw mechanism (98) adapted to operate the drive shaft (97) on whose axis at least one pump (200) is arranged, preferably a plurality of pumps (200), (200a), (200b) adapted to compress the atmospheric air inside an appropriate storage tank (6) of said air, till a maximum pressure of 100 atmospheres is reached, thanks to the synchronous action of at least two couples of valves (13) connected to said pump (200) in such a way that every single pumping chamber (15) and (16) of each cylinder (90) is connected to said couple of valves (13) controlled by the control unit (14), which are adapted to open and close so as to exploit the compression action of the cylinder (17) during both the back and forth steps, and at least one pressurized piping (3) deriving from said storage tank (6) on which at least one pressure reducer (500) and one primary electrovalve (150) are placed, the latter being adapted to feed, at a pressure of about 10 bars, at least one pneumatic actuator (1) arranged on the axis (50) in turn connected, through at least one pressurized piping (4), to at least one secondary pneumatic actuator (1a), preferably a plurality of secondary pneumatic actuators (1a, 1b, 1c) connected in parallel one to another and arranged along said axis (50) too, which are adapted to be activated by the compressed air emitted by the primary pneumatic actuator (1) and entered into the pressurized piping (4), said pressurized piping (4) being provided with the secondary electrovalve (298) so as to allow said pneumatic actuators (1a, 1b, 1c) to be activated in parallel, these actuators also rotating, by their reciprocating rotary motion, the shaft (99) placed along said axis (50) with a reciprocating rotary motion, and said device (100) being provided with at least one transmission assembly (21) placed along said axis (50) and adapted to transform the reciprocating rotary motion of a first element, i.e. of the actuators (1), (1a), (1b), (1c), into the continuous rotary motion of a second element connected thereto, i.e. of the flywheel (58) connected to the electric generator (33).

2. Device (100) for the production of electric power according to claim 1, wherein the pneumatic actuators (1, 1a, 1b, 1c) are neatly aligned along an end of the axis (50), on the contrary the central portion of said axis (50) is within the transmission assembly (21) itself, the gear wheel (26) being mounted on said inner portion of the axis (50), the first freewheel (28) is interposed between said gear wheel (26) and the shaft (99) and is provided with only one and fixed mesh way, a second gear wheel (27), adapted to engage with said first gear wheel (26) and a gear pulley (20), in its turn connected to the second gear pulley (29) by a first drive belt (22), are keyed on a second shaft (25) parallel to said first shaft (99), said second gear pulley (29) is keyed on the second shaft (25) on which also the second gear wheel (27) is installed, the first gear pulley (20) is keyed on the first shaft (99) on which also the first gear wheel (26) is mounted with the respective first freewheel (28), a second freewheel (51) is installed between said first gear pulley (20) and said first shaft (99) and comprises a mesh way opposite with respect to that of the first freewheel (28), the electric generator (33), being keyed on a third shaft (44) with which it rotates integrally always in the same way, has now to rotate in a constant way because of the effect of the transmission system (21), the first shaft (99) and the third shaft (44) are arranged on the same axis (50) thanks to the third shaft (44), having the longitudinal axis perfectly aligned to that of the first shaft (99) in its turn coincident to the axis (50), being placed side by side in parallel to the second shaft (25), the shaft (99) and the shaft (44), although being perfectly aligned, are separated and aligned one to another, the second shaft (25) and the third shaft (44) are connected one to another by means of a second toothed belt (47) placed between a third gear pulley (45) and a fourth gear pulley (46) keyed on the second shaft (25) and the third shaft (44), respectively, the third gear pulley (45) and the fourth gear pulley (46) thanks to the afore said kinematic systems, independently from the activation way of the pneumatic actuator (1), continue rotating in the same direction, thereby transmitting such a constant rotary movement to the electric generator (33), the flywheel (58) placed on the shaft (44) being between the transmission assembly (21) and the electric generator (33).

3. Device (100) for the production of electric power according to claim 1, wherein by source of renewable energy is meant a wind, photovoltaic or hydroelectric energy source or a combination thereof.

4. Device (100) for the production of electric power according to claim 1, wherein the control unit (14) controlling the valves (13), is connected to at least one digital analog manometer (199), preferably a plurality of digital manometers (199), adapted to detect the pressure inside every single independent zone of the tank (6).

5. Device (100) for the production of electric power according to claim 1, wherein the electric motor (5) is connected to a screw mechanism (98) provided with ball bearings and adapted to operate the drive shaft (97).

6. Device (100) for the production of electric power according to claim 1, wherein the pneumatic actuator (1) is provided with reciprocating rotary motion with an oscillation angle of at least 270 degrees.

7. Device (100) for the production of electric power according to claim 1, wherein the pneumatic actuator (1) is provided with reciprocating rotary motion with an oscillation angle lower than 270 degrees.

8. Device (100) for the production of electric power according to claim 1, wherein the primary pneumatic actuator (1) is directly fed by the pressurized piping (3) through the primary electrovalve (150) and in that the air, emitted from said primary pneumatic actuator (1), feeds a plurality of secondary pneumatic actuators arranged in parallel one to another and adjusted by at least one secondary electrovalve (298) that is arranged on the pressurized pipings (4), through the pressurized pipings (4).

9. Device (100) for the production of electric power according to claim 1, wherein the storage tank (6) of the compressed air can be an ordinary tank conveniently sized, or preferably a gallery, or tunnel, or any other hermetic cavity no longer in use.

10. Device (100) for the production of electric power according to claim 1, wherein the storage tank (6) of the compressed air is a multistage tank composed of a plurality of separated zones, preferably four separated zones, connected one to another by at least one pressure reducer (297) represented by an electrically controlled ordinary tap adapted to electrically open and close by an ordinary spring mechanism.

11. Device (100) for the production of electric power according to claim 1, wherein the compressed air fed by the primary pneumatic actuator (1) has a pressure comprised between 5 and 20 bars, preferably 10 bars.
